(19) United States
(12) Patent Application Publication
(10) Pub. No.: US 2005/0154851 A1
(43) Pub. Date: Jul. 14, 2005

(54) Fast, high reliability dynamic memory manager

(76) Inventor: Andrew A. Charles, Naperville, IL (US)

Correspondence Address: WERNER ULRICH, 434 MAPLE STREET, GLEN ELLYN, IL, 60137-3826, US

(21) Appl. No.: 10/756,861

(22) Filed: Jan. 14, 2004

(51) Int. Cl. G06F 12/00

(52) U.S. Cl. 711/170

(57) ABSTRACT

A method and apparatus for allocating and deallocating memory in a multi-processing system. Each unit of user memory has an associated control block. All units of user memory are contiguous as are all control blocks. Available user memory blocks are stored in linked lists, one linked list for each range of user memory block sizes. When a user memory block is allocated, a memory block is seized using a linked list of adequate size memory blocks; the surplus of the adequate size memory block beyond what is needed in the request for user memory is retained as available user memory and is added to another appropriate linked list of available memory. When deallocating, both the memory block being deallocated and, if available, the previous and/or next memory block are added to create a merged memory block. The merged memory block is then restored as available memory and added to the appropriate one of the linked lists of available memory blocks while the previous and/or next memory blocks, if available, are removed from the list of available memory blocks of the size of the previous or next block.

### TECHNICAL FIELD

This invention relates to a method and apparatus for the dynamic allocation and deallocation of random access memory of a processor.

### BACKGROUND OF THE INVENTION

Processing systems, especially those employing a plurality of processes, usually need a dynamic memory allocation system to assign memory to each process as it is needed (allocation) and to free memory that is no longer needed so that it can be used by other processes (deallocation). In the prior art, existing memory managers suffer from one or more of the following problems.

1. The memory is distributed into multiple pools of different sized blocks so that memory can be seized both for processes that require small blocks of memory and for processes that require large blocks of memory. These pools are engineered based on general statistics and not on the particular needs of the moment. Furthermore, the number of pools and their associated block sizes forces allocation request sizes to be effectively rounded up to the block size associated with the target pool, wasting the unused portion of the allocated block.

2. The memory is in a single pool from which blocks of varying sizes can be allocated. This avoids the engineering issues but (de)allocation methods are often run-time inefficient or lead to excessive fragmentation of the pool. That is, the size of the largest available contiguous block of memory in the pool tends to shrink.

3. Control data for idle blocks is stored either in the idle block itself or in memory adjacent to it. Common program bugs such as writing past the end of an allocated buffer corrupt the control data itself instead of or in addition to the contents of the next buffer.

Reclamation of lost memory collection is a difficult problem. Memory is “lost” if it is no longer being used but appears to be unavailable for allocation. This is typically the result of flaws in the applications using the allocable memory but may also result from unexpected events. For example:
Code allocates 2 buffers, ends up only using 1 and forgets to release the other;
Code allocates a buffer, takes some failure and returns before releasing the allocated buffer;
An interrupt causes a process reset thus losing a pointer to allocated memory.

In summary, a problem of the prior art is that there is no dynamic memory manager which is fast, capable of administering requests for both large and small blocks of memory, and wherein lost blocks of memory can be identified for reclamation.

### SUMMARY OF THE INVENTION

The above problems are solved to a major degree in accordance with this invention wherein: control blocks are associated with fixed size user units of memory, one control block for each such fixed size user unit such that contiguous user units have contiguous control blocks; groups of contiguous control blocks, each group thus associated with a contiguous block of memory, are allocated by a search of linked lists containing entries for idle block groups, such that every block group size is efficiently and uniquely mapped to the first list containing groups at least as large as the requested size, the size ranges associated with the lists are mutually exclusive and lists are linearly ordered by the minimum size of block groups they contain; when allocating an idle block for user block use, any surplus that is not required by the allocation request is returned as an available block of user memory to the linked list of block groups whose size includes sizes at least as large as the surplus block; when deallocating memory both the block before and the block after the memory to be deallocated are examined to see if they are idle; if either one is idle, the idle block(s) are removed from their associated linked list(s) of available memory and merged with the block to be deallocated to create a larger block to be deallocated. Advantageously, at the expense of a relatively small amount of memory (one control block for each basic unit of memory) it is possible to have a rapid search for new memory (allocation) and a rapid deallocation process, which together continuously refine the memory assignment to create blocks of available memory. Furthermore, in systems where high usage levels typically result in greater fragmentation of the allocable memory, the allocation search time in accordance with the invention will tend to be less because the likelihood of finding an acceptably sized fragment on an earlier list is greater.

Control blocks and user memory are one-to-one to make translating from the user block address, which is all the application ever sees, back to the control block address simple and efficient. Translations in the other direction are required internally since the algorithm acts on the control blocks but a user block address is a required output.

In accordance with one specific implementation of Applicant's invention, there is a linked list for every multiple of the basic memory unit, in this case 64 bytes, and the search for a linked list that contains an idle block is performed by making a binary tree search of all lists for blocks at least as large as the block size of the allocation request. Advantageously, this arrangement allows for a very rapid search to find the linked list that contains the most appropriate block size of memory.

In accordance with another feature of Applicant's invention, multiple sets of linked list are provided. The first set is a set of linked lists, each list for a multiple of the basic memory size block up to a maximum number. A separate set of linked lists is provided for each order of magnitude larger blocks than the previous set of lists. These superblocks are also arranged in linked lists, each linked list for a multiple of a superblock size. Advantageously, this arrangement allows for a fast search for an available memory block of an appropriate size for both small memory blocks and large memory blocks. The number of linked lists is limited and the space for the linked lists head cells and the linked lists is minimized by having linked lists only for small size blocks up to a first maximum and supersize blocks beyond that maximum.

In accordance with another feature of Applicant's invention, busy and idle bit maps are provided in a one-to-one correspondence with control blocks. Because there is a control block for each unit of user memory, a busy bit and an idle bit can be provided for each control block, the busy bit being marked and the idle bit cleared whenever the first control block for a user block is seized and the idle bit marked and the busy bit cleared whenever the first control block for a user block is deallocated. The idle and busy bit maps can be used to reconstruct the control blocks (by looking for the next set bit in either map) if, as a result of a program bug, these control blocks are overwritten.

In addition, in order to help debug programs an allocate/deallocate bit map is provided which is marked whenever a corresponding user block of memory is deallocated. Use of this bitmap can be controlled based on time, user or other criteria such that a “snapshot” of the memory being still in use associated with that criterion is available.

### BRIEF DESCRIPTION OF THE DRAWING(S)

FIG. 1 is a memory layout diagram showing that there is one control block for each basic user block;

FIG. 2 shows the layout of control blocks including the different memory entries in a first control block for a user block, a last control block for a user block, a control block adjacent to the first or last control block, and the other control blocks associated with a single user block group;

FIG. 3 illustrates the use of a head cell availability bit map and the head cells used for finding an available user block;

FIG. 4 is a flow diagram illustrating the allocation process;

FIG. 5 is a flow diagram illustrating the deallocation process;

FIG. 6 is a memory layout diagram illustrating an audit and debug arrangement in accordance with this invention.

FIG. 7 is a memory layout illustrating the correspondence between control blocks and a plurality of bit maps.

### DETAILED DESCRIPTION

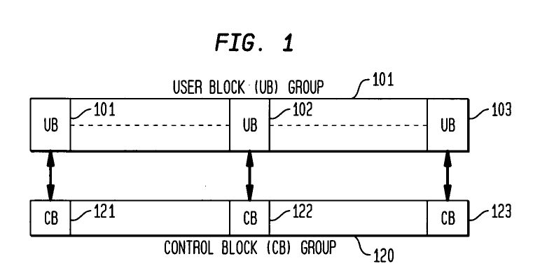

FIG. 1 is a memory layout showing that for each user block there is a corresponding control block. This makes it possible, given the address of the control block, to find the user unit and vice versa. In Applicant's particular implementation, a control block is six bytes long and the user unit is 64 bytes long. This small investment in control block memory pays large dividends in providing for a flexibly reliable and fast dynamic memory manager. With this arrangement, if a user block consists, for example, of six 64 byte units, then the corresponding control block group would have six six byte control blocks. There are control blocks for the entire range of user memory. Also note that control blocks are not physically located in memory next to the user blocks. Thus common program bugs such as writing past the end of an allocated buffer only affect the next buffer, not the control data itself.

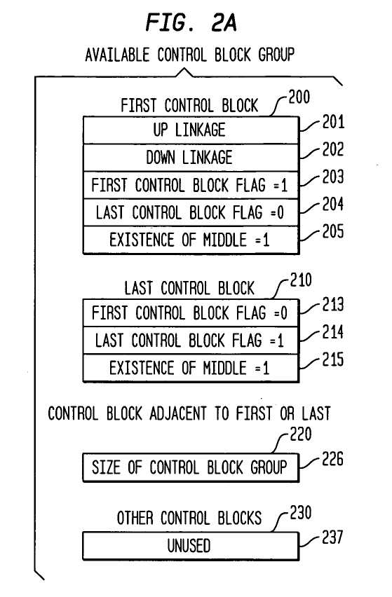

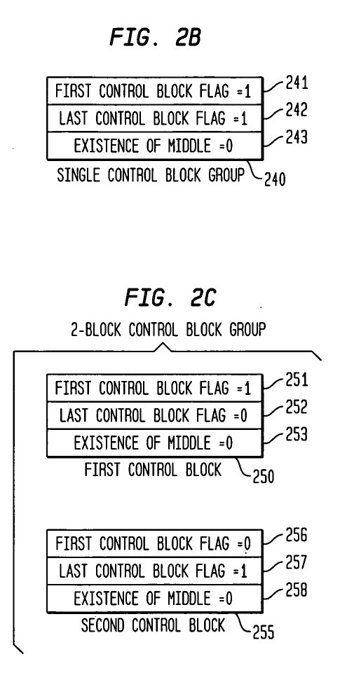

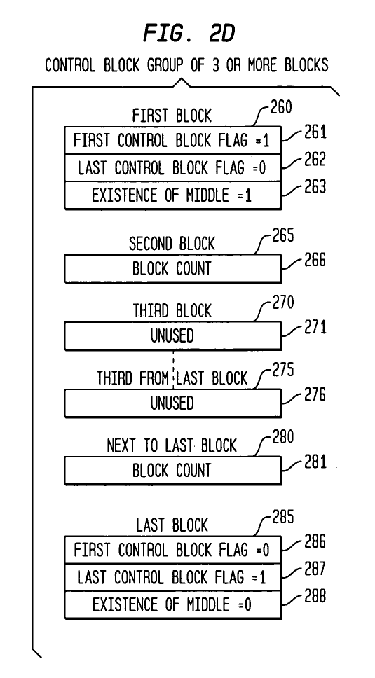

FIG. 2A shows the layout of an idle control block group. The first control block 200 in the group contains a linkage with other idle control block groups; this linkage is used when allocating memory as will be explained with respect to the subsequent drawings. In addition, the first control block of the group contains three flags, one flag 203 to identify that this is the first control block, a second flag 204 to identify that it is not the last control block, and a third flag 205 to indicate the existence or non-existence of one or more middle control blocks. The last control block 210 contains the same three flags referred to above for the first control block, namely, a first control block flag 213, a last control block flag 214, and a middle control block flag 215 to indicate or deny the existence of any middle control blocks.

Control block 220 is a control block adjacent to the first or the last control block of a group. If the group has exactly three control blocks there is only one control block 220; if the group has more than three control blocks there will be two control blocks 220. A control block 220 contains an entry indicating the size of the control block group 226. (It also has its first control block flag and last control block flag both set to zero (false)).

The other control blocks 230 of the group do not contain any useful information. However, it is not necessary to clear information in these control blocks during the allocation or deallocation process since they are either overwritten before being used or remain unaccessed.

If a memory control block (MEMCB) 240 is marked as being both first 241 and last 242, and no middle 243, the group is a single block (so there are no middle blocks). (FIG. 2B)

If first and last MEMCBs are different but there are no middle blocks, the group has two buffers in it. (FIG. 2C). The first control block 250 has the first control block flag 251 marked 1, the last control block flag 242 marked 0 and the existence of middle block 253 marked 0. The second control block 255 has the first control block flag 256 marked 0, the last control block flag 257 marked 1 and the existence of middle blocks 258 marked 0.

If the first and last MEMCBs are different and there are middle buffers, the number of blocks in the group is stored in the second and second to last MEMCBs (which are the same in a 3 block group). The block count can be used to find the opposite end of a group starting from either end. Note that the block count value in a “middle” MEMCB does not require additional memory in the structure. It can be stored in the same location as either the next or previous linkage fields since they are only used in the first MEMCB in a block. (FIG. 2D)

Effectively this means that the MEMCBs at either end of a block group are linked in a point-to/point-back relationship and data at either end can be used to find the other end.

Only the first MEMCB in a group uses the linkage fields and the busy/idle status. The last MEMCB in a group has the other attributes populated to support defragmentation. When a group is being idled, the previous MEMCB in memory can be used to find the beginning of the previous block in memory. If it is idle, the two can be merged.

In FIG. 2D, first control block 260, has its first control block flag 261 marked 1, its last control block flag marked 0 and its existence of middle flag marked 1. The second control block 265 contains a count 266 of the number of control blocks. For a control block group of three, blocks 270, 276 and 280 are missing. For a control block group of four, blocks 271 and 276 are missing and block 280 contains the block count 281. For a control block group of five or more, there are N-4 control blocks 270, . . . , 275 each containing an unused field 271, . . . , 276. The last control block 285, has its first control block flag 286 marked 0, its last control block flag 287 marked 1 and its existence of middle 288 marked 1.

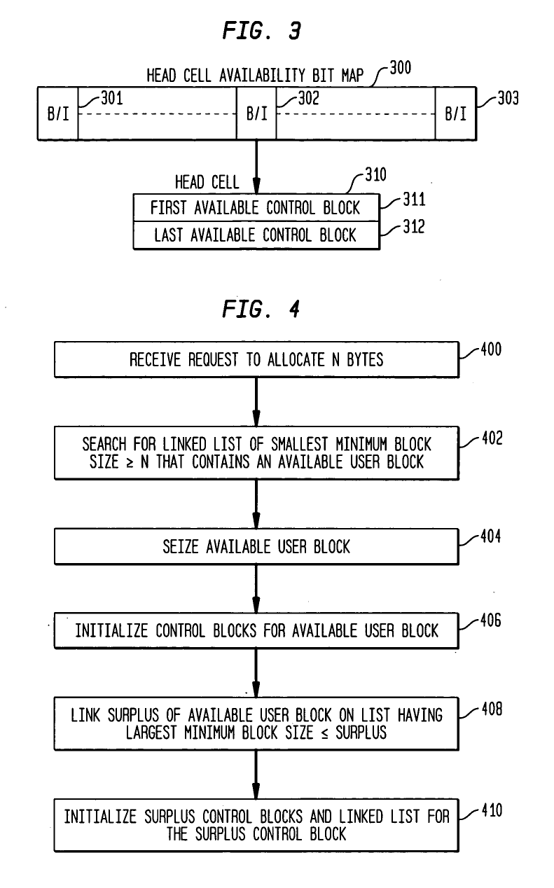

FIG. 3 is used to illustrate the arrangement of linked list head cells and a head cell availability bit map used to find a linked list of memory block groups that can be used to respond to a request for memory allocation. The linked list is a two-way linked list in order to allow a block group to be unlinked (for purposes of defragmentation during deallocation) even when that block of user memory is in the middle of the linked list.

The head cell availability map 300 containing a first busy-idle bit 301, a last busy-idle bit 303 and intermediate busy-idle bits 302; this availability map contains busy-idle bits in a one-to-one correspondence to the linked list head cells. When an allocation request is received the busy-idle bit for linked list for block groups that are at least as large as the size of the block of memory being requested in the allocate request and all busy-idle bits for larger blocks of memory are potentially examined. A binary search tree is used to find the busy-idle bit that is marked idle (i.e., memory available) that corresponds to the linked list with the smallest available satisfactory block group. Once this linked list is found, the corresponding head cell is located because of the one-to-one correspondence. This head cell then provides the address of the first available control block for a satisfactory memory block 311.

Each tree has 1 element for each list in the group as its base and then 1 parent for every two child elements. Tree element ‘k’ has child elements ‘2k’ and ‘2k+1’. A tree element is TRUE if and only if one of its child elements is TRUE. At the bottom level, a tree element is TRUE if and only if the associated list is non-empty.

To allocate a block, the “best fit” list is first determined based only on the size of the request. If that list is empty, the associated binary tree is searched as follows:

1. Search up the tree until the current branch is the left-hand (2k) child of its parent and the right hand child of the parent is TRUE.

2. If the top of the list is reached before the conditions are met, search for the next populated group by looking at the top element of each succeeding tree. If none are TRUE then the other groups are all empty and the request cannot be satisfied. Otherwise, move to the top of the first populated group.

3. Now search down from the current position if at the top of a new group or otherwise from the right-hand child of the parent. Use the left-hand (2k) child whenever it is TRUE and the right-hand child otherwise. When the bottom level is reached, that is the next non-empty list from the starting point.

In other words, move up from the current position until the tree shows a non-empty list exists to the right and then find the lowest-indexed such list. Here is an illustration of how a tree would look for a set of 8 lists.

lists:

1

| 2 | | 3 | |
|---|---|---|---|
| 4 | 5 | 6 | 7 |

| | | | | | | | |
|---|---|---|---|---|---|---|---|
| 8 | 9 | 10 | 11 | 12 | 13 | 14 | 15 |
| [1] | [2] | [3] | [4] | [5] | [6] | [7] | [8] |

Thus the maximum search time (starting at group 1 list 1 when only lists in the top group are populated) for M groups of N lists would be 2*(log2(N))+(M−1). In the example illustrated this would be 2*(log2(8))+(M−1)=5+M. This formula can be used to adjust the number of lists and groups for maximum efficiency for a given range of supported block group sizes.

FIG. 4 is a flow diagram illustrating the allocate process. A request is received to allocate N bytes (action block 400). A “best fit” list is determined based on the requested size. The “best fit” is the list having a range that includes the smallest minimum block size≧N bytes. If that list is empty, a binary search tree is used to find the next populated list which contains block groups larger than the “best fit” list. The head cell availability map is searched in order to find the linked list of the user blocks that have a minimum block size at least as great as N and that contains an available user block (action block 402). The first block from that list is then seized (action block 404), and the control blocks for the user block group portion of the seized block group initialized (action block 406).

If the user block that was seized contains a surplus≧one unit, then the surplus memory is made available through proper initialization of the control blocks for the surplus and the corresponding linked list of the blocks at least as large as the surplus (action block 408). In other words, we link the surplus block to the list just before the first list for which it would be too small. The surplus control blocks and the linked list for those control blocks are initialized (action block 410). As a result of these actions, a block of memory adequate to satisfy the allocate request is provided to the user and any memory associated with surplus blocks from the seized block group is returned to available memory. This is part of the process of making fragments of memory available to subsequent users.

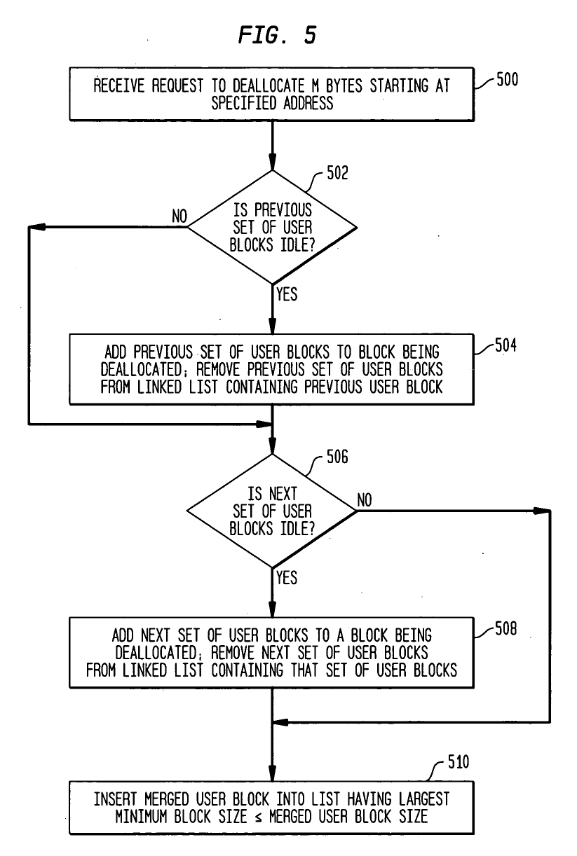

FIG. 5 is a flow diagram illustrating the deallocation process. A request is received to deallocate a particular user block (action block 500). Test 502 determines whether the previous set of user blocks, i.e., the user blocks immediately adjacent to the deallocated user blocks, is available. By examining the control blocks immediately before the control blocks of the user block being deallocated, it is possible to determine the size of the user block immediately adjacent to the user block being deallocated. The first control block associated with a previous user block is examined to see if the block of memory immediately adjacent to the memory being deallocated is idle (test 502). If it is found that the previous user block is idle then the previous user block is added to the block being deallocated and that previous user block is removed from the linked list containing available user blocks (action block 504). Next, test 506 is used to determine if the next user block is available. If so, then that next user block is added to user block being deallocated and that next user block is removed from the linked list which contains that next user block (action block 508). Finally, the merged user block is inserted at the end of the appropriate linked list having a minimum block size less than or equal to the merged user block size (action block 510).

Only the first MEMCB in a block uses the linkage fields and the busy/idle status. The last MEMCB in a block has the other attributes populated to support defragmentation. When a block is being idled, the previous MEMCB in memory can be used to find the beginning of the previous block in memory. If it is idle, the two can be merged.

Similarly, the first MEMCB of a block being idled can be used to find the first MEMCB of the next block in memory. If it is idle, it too can be merged with the one being idled. Note that there is no need to look beyond this block group since the blocks on the idle list are already fully defragmented. Therefore the blocks after the next and previous blocks in memory must already be in use (or they are the first/last blocks in the whole range).

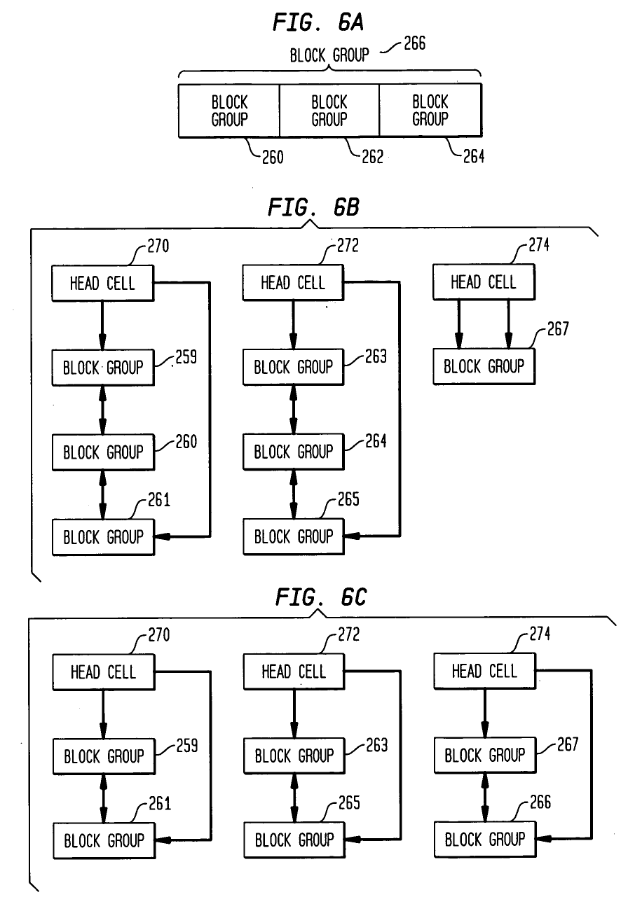

FIG. 6 illustrates how the process of deallocation and combining operates. Block groups 260, 262 and 264 are adjacent (FIG. 6A). As shown in FIG. 6B, block groups 260 and 264 are idle (available). Block group 260 is in the list of available blocks governed by head cell 270. Block group 264 is in the list of available block groups governed by head cell 272. The available block groups governed by head cell 270 are linked by a two-way linked list as is shown by the arrows. Head cell 270 is directly linked to block group 259 which is linked to block group 260 which is linked to block group 261 which is linked back to head cell 270. Similarly, head cell 272 is linked to block group 263 which is linked to block group 264 which is linked to block group 265 which is linked back to the head cell 272. Finally, head cell 274 is linked to block group 267. The status at the time of FIG. 6B is that block groups 260 and 264 are available and block group 262 was in use but is now being made available. The memory manager examines the contents of block 260 to determine if block group 260 is available. If so, then block groups 262 and 260 are merged and block group 260 is removed from the blocks governed by head cell 270. The status of block group 264 adjacent to block group 262 on the other side is examined. If, as in this case, block group 264 is available then block group 264 is removed from the list governed by head cell 272 and is merged with the combination of block groups 260 and 262 to form a larger block group 266 (FIG. 6A). This larger block is then added to the block groups governed by an appropriate head cell 274. This final status is shown in FIG. 6C.

This deallocation process is another part of the arrangement to avoid fragmentation of available memory. Note that it is only necessary to examine immediately adjacent blocks for the presence of an idle block since two adjacent idle blocks would be avoided by this deallocation process.

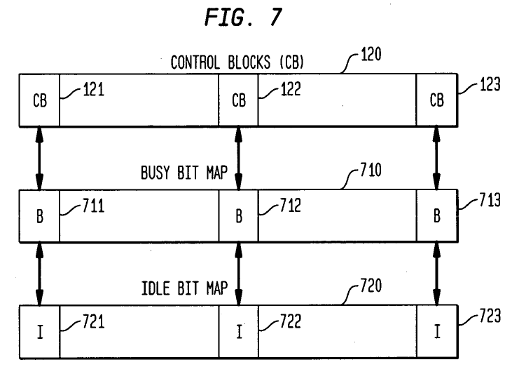

FIG. 7 illustrates an additional feature of Applicant's invention. In a system such as this, if the control blocks should be inadvertently overwritten as a result of a program bug, the system is likely to crash. Applicant has found a way of avoiding the situation by providing busy bit maps 710 and idle bit maps 720 having a one-to-one correspondence with the control blocks. Each active busy bit (711, . . . , 712, . . . , 713) represents the beginning of a control block group for active user memory. Each active idle bit (721, . . . , 722, . . . , 723) similarly represents the beginning of a control block group for available user memory. By measuring the difference between consecutive active busy or idle bits, the size of each control block group can be established. From the size of the idle control blocks, an appropriate available memory linked list entry can be generated. The linked list entry in the first control block is only used for idle control block groups. In order to use this feature it is only necessary to initialize a busy bit or an idle bit when memory is allocated or deallocated.

Similarly, if the control blocks have not been overwritten but the busy bit map and/or the idle bit map had been overwritten, then the busy bit map and the idle bit map can easily be constructed from the contents of the control blocks.

Some systems support a “write protection” such that blocks of memory meeting certain criteria (typically a size and address offset requirement) can be marked such that any attempt to write into them will result in a processor exception. Debugging data such as function trace information can be output when such an exception occurs. One common bug for allocable memory users is to write past the end of their allocated buffer. By adjusting the user buffer size and location, the algorithm of this document can be modified so an extra write-protected buffer is allocated at the end of each allocated block of user memory. By adjusting the address returned to the user so it is N bytes before the allocated write-protected block (assuming the request was for N bytes) any buffer overflow will immediately result in an exception and a function trace pointing to the line of code that did it. This is a “debug mode” of operation because of the overhead of the larger (in most cases much larger) buffer size and the extra buffer per allocation. However, it has proved itself to be very useful in the debug stages.

The above description is of one preferred implementation of Applicant's invention. Other implementations will be apparent to those of ordinary skill in the art without departing from the scope of the invention. The invention is only limited by the attached claims.

1. A method of allocating and deallocating memory comprising the steps of:
assigning to each basic unit of user memory a corresponding memory control block;
collecting groups of contiguous available control blocks into linked lists, each list for storing available control block groups having an associated minimum size;
in response to a request for a block of user memory, searching for a linked list having available blocks of user memory at least as large as the requested size;
seizing a block of user memory of the required size and making available any surplus representing the difference between the requested size of memory and the size of the seized block of user memory;
when deallocating memory, testing whether user blocks of memory immediately adjacent to the deallocated block are available and if available merging the available blocks to the block being deallocated to create a merged deallocated block; and
inserting the merged deallocated block into a linked list of available blocks of memory for containing blocks of memory of the size of the merged block;
whereby the adding of said surplus block and the process of creating a merged deallocated block helps to avoid fragmentation of memory.

2. The method of claim 1 wherein the step of grouping available blocks of user memory into linked lists comprises the step of:
providing a linked list for each size that is a multiple of a basic block size.

3. The method of claim 2 wherein said basic block size is 64 bytes.

4. The method of claim 2 wherein lists are provided for each block size that is a multiple of a basic block size up to some limit and wherein block sizes above said limit are in multiples of a superblock size, said superblock size being larger than said basic block size.

5. The method of claim 4 wherein said superblock size is 4 K bytes.

6. The method of claim 1 in which the step of collecting available block groups into linked lists comprises the step of grouping available block groups into two-way linked lists.

7. The method of claim 1 wherein the step of searching for a linked list having available block groups associated with user memory at least as large as the requested size comprises the steps of:
ordering said linked lists by size;
finding the linked list having a minimum size at least as large as the requested size; and
subsequently searching over linked lists for blocks of memory larger than the minimum size linked list until a linked list is found having an available block of user memory.

8. The method of claim 1 further comprising the step of:
storing availability bits for each basic unit of user memory;
in case said memory control blocks are inadvertently overwritten, recreating a new set of linked lists from data of said availability bits.

9. The method of claim 1 wherein the memory control blocks are contiguous to each other and located separately from the user memory.

10. The method of claim 1 wherein user memory is in one contiguous block and control memory is in a separate contiguous block and wherein addresses of each basic unit of user memory and each control block are related by a corresponding distance from a starting point of said user memory and said control block memory.

11. Apparatus for allocating and deallocating memory comprising:
means for assigning to each basic unit of user memory a corresponding memory control block;
means for collecting groups of contiguous available control blocks into linked lists, each list for storing available control block groups having an associated minimum size;
means, in response to a request for a block of user memory, for searching for a linked list having available blocks of user memory at least as large as the requested size;
means for seizing a block of user memory of the required size and making available any surplus representing the difference between the requested size of memory and the size of the seized block of user memory;
when deallocating memory, means for testing whether user blocks of memory immediately adjacent to the deallocated block are available and if available merging the available blocks to the block being deallocated to create a merged deallocated block; and
means for inserting the merged deallocated block into a linked list of available blocks of memory for containing blocks of memory of the size of the merged block;
whereby the adding of said surplus block and the process of creating a merged deallocated block helps to avoid fragmentation of memory.

12. The apparatus of claim 11 wherein the means for grouping available blocks of user memory into linked lists comprises:
means for providing a linked list for each size that is a multiple of a basic block size.

13. The apparatus of claim 12 wherein said basic block size is 64 bytes.

14. The apparatus of claim 12 wherein lists are provided for each block size that is a multiple of a basic block size up to some limit and wherein block sizes above said limit are in multiples of a superblock size, said superblock size being larger than said basic block size.

15. The apparatus of claim 14 wherein said superblock size is 4 K bytes.

16. The apparatus of claim 111 in which the means for collecting available block groups into linked lists comprises means for grouping available block groups into two-way linked lists.

17. The apparatus of claim 11 wherein the means for searching for a linked list having available block groups associated with user memory at least as large as the requested size comprises:
means for ordering said linked lists by size;
means for finding the linked list having a minimum size at least as large as the requested size; and
means for subsequently searching over linked lists for blocks of memory larger than the minimum size linked list until a linked list is found having an available block of user memory.

18. The apparatus of claim 11 further comprising:
means for storing availability bits for each basic unit of user memory;
in case said memory control blocks are inadvertently overwritten, means for recreating a new set of linked lists from data of said availability bits.

19. The apparatus of claim 11 wherein the memory control blocks are contiguous to each other and located separately from the user memory.

20. The apparatus of claim 11 wherein user memory is in one contiguous block and control memory is in a separate contiguous block and wherein addresses of each basic unit of user memory and each control block are related by a corresponding distance from a starting point of said user memory and said control block memory.
